(19) United States
(12) Patent Application Publication
(10) Pub. No.: US 2016/0081315 A1
(43) Pub. Date: Mar. 24, 2016

(54) CREEL AND METHOD OF MAKING A CREEL FOR TRAPPING CRUSTACEANS

(71) Applicant: Riverdale Mills Corporation, Northbridge, MA (US)

(72) Inventor: James M. Knott, JR., Northbridge, MA (US)

(21) Appl. No.: 14/861,581

(22) Filed: Sep. 22, 2015

Related U.S. Application Data
(60) Provisional application No. 62/053,506, filed on Sep. 22, 2014.

(51) Int. Cl. A01K 69/08; A01K 99/00

(52) U.S. Cl. CPC A01K 69/08; A01K 99/00

(57) ABSTRACT

A cage for trapping crustaceans constructed in the shape of a rounded top creel. The body panel is bent at two perpendicular angles to create the base, while the top is rounded to create a curved surface. The front and back of the body are further enclosed by flat mutually spaced line wire and fill wire. The similarly constructed front and back panels are secured to the front and back openings of the body, while two cutouts in the vertical sides of the body are replaced with nylon funnels to allow crustaceans to enter the trap.

### PRIORITY DATA

This invention claims priority to U.S. Provisional Patent Application Ser. No. 62/053,506 filed Sep. 22, 2014, which is hereby incorporated by reference.

### BACKGROUND

This invention relates generally to submersible traps that are deployed on a sea bed to capture crabs and other like crustaceans, and is concerned in particular with improvements in the construction and manufacture of such traps.

The crab traps currently used are generally formed by a rectangular shaped base, vertical walls, a rounded top, and enclosed by a D-shaped front and back cover panels. Mesh entry funnels are then inserted into predefined slots in the side of the trap, allowing crab entry into the trap, attracted by suspended bait within the trap. The funnels are made in such a way as crabs may not exit once they enter, due to the decreasing diameter of said funnels.

Creel cages are typically constructed of a steel reinforced frame, with panels constructed of nylon netting. These cages are thus heavy, difficult to construct, and easily subject to wear and corrosion as they age. Furthermore the deployment of these cages proves awkward and difficult in the adverse weather, seas, and conditions typical of crab fishermen.

Thus, a need exists for a less expensive, lighter, and more durable crab cage to be produced.

### SUMMARY OF THE INVENTION

A crab trap in accordance with an embodiment of the present invention includes a continuous body constructed of a bent rectangular panel to form a creel. The trap also includes uniformly spaced line wires intersecting predefined fill wires, of half spacing on the bottom surface of the cage and full spacing on the sides, top, front, and back of the cage. Two discreet openings are cut out of the vertical sides of the cage, one on the back right, the second on the front left. Fastened to these two openings are two nylon mesh funnels leading towards the interior of the cage.

In accordance with another embodiment, the invention provides a method of forming a cage for trapping crustaceans constructed in the shape of a rounded top creel, wherein the method includes the steps of providing a rectangular mesh body panel; providing a curve in said rectangular body mesh panel such that a first portion of the mesh body panel is provided as a base of the cage, and second portion of the mesh body panel is provided as side walls and the rounded top of the cage; and attaching an edge of the first portion of the mesh body panel to an edge of the second portion of the mesh body panel.

In accordance with a further embodiment, the invention provides a method of forming a cage for trapping crustaceans, where the method includes the steps of: providing a rectangular wire mesh body panel having parallel fill wires extending from a bottom edge to a top edge of said panel, and parallel line wires extending from one side edge to the other side edge of said panel, said fill and line wires being secured to one another at cross over locations to thereby define discrete rectangular openings; the body panel consisting of an arrangement of half and full spaced fill wires in accordance with the preceding drawings; and the body panel being trimmed to create two side openings as shown in the preceding drawings; interconnecting the side edges, consisting of two fill wires, of the thus formed body panel; providing two smaller rectangular wire mesh body panels having parallel fill wires extending from a bottom edge to a top edge of said panel, and parallel line wires extending from one side edge to the other side edge of said panel; trimming said panels to enclose the front and back openings produced from interconnecting the sides of the thus formed body panel; interconnecting said front and back panels to the exposed edges of the thus formed body panel; and interconnecting two nylon funnels to the two cut opens in the side of the body panel described above.

These and other features and advantages of the present invention will now be described in greater detail with reference to the accompanying drawings, wherein:

### BRIEF DESCRIPTION OF THE DRAWINGS

The following description may be further understood with reference to the accompanying drawings in which:

FIG. 1 is a perspective view of a crab cage constructed in accordance with an embodiment of the present invention;

FIG. 2 is a top view of the trap shown in FIG. 1;

FIG. 3 is a front view of the trap shown in FIG. 1;

FIG. 4 is a bottom view of the trap shown in FIG. 1;

FIG. 5 is a side view of the trap shown in FIG. 1;

FIG. 6 is a top view of the horizontal rectangular panel of a welded wire mesh used in the formation of the body of the trap shown in FIG. 1;

FIG. 7 is an end view of the rectangular panel being formed into the shape for the trap; and

FIG. 8 is a view of the finished creel cage body frame for the trap shown in FIG. 1.

The drawings are shown for illustrative purposes only.

### DETAILED DESCRIPTION

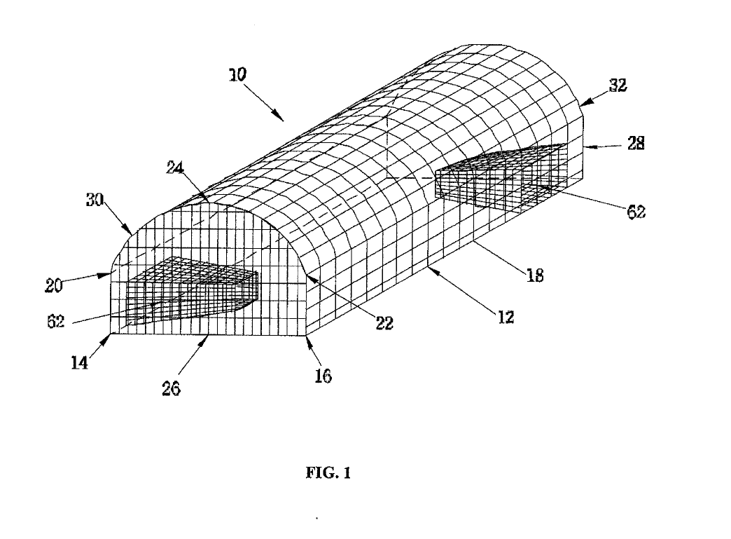

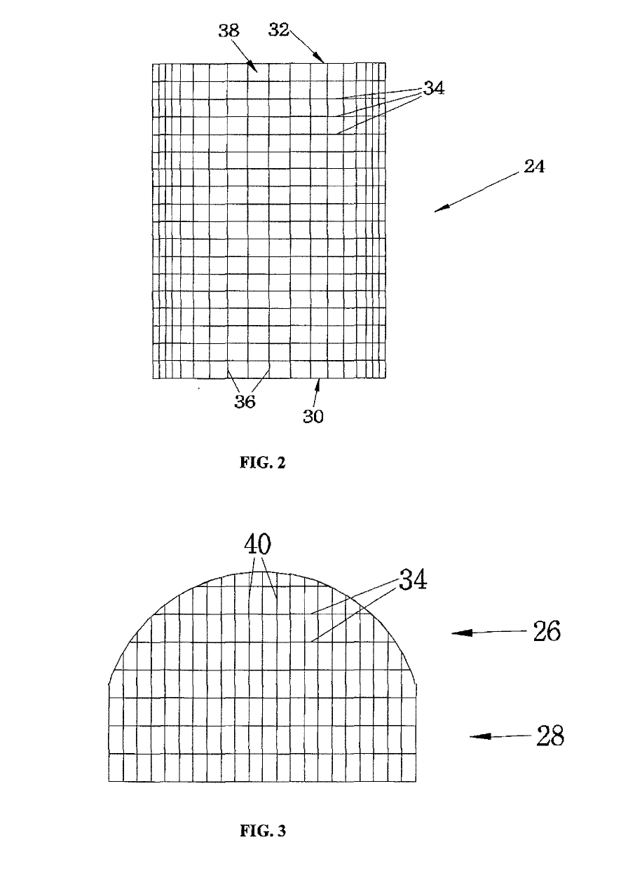

With reference initially to FIGS. 1-5, a crab trap is generally depicted at 10. The trap includes a continuous mesh body 12, featuring two perpendicular bends 14 and 16 forming the flat rectangular base 18. The remainder of the body is created by making two obtuse bends 20 and 22 bordering the curved top of the body 24.

As shown in FIG. 3, the trap 10 features a front panel 26 and an identical back panel 28, connected by clips (not shown) on the front contact edge 30 and back contact edge 32. These panels 26 and 28 are formed by shaping mutually and uniformly spaced line wire 34 and fill wire 36 to create a square mesh 38.

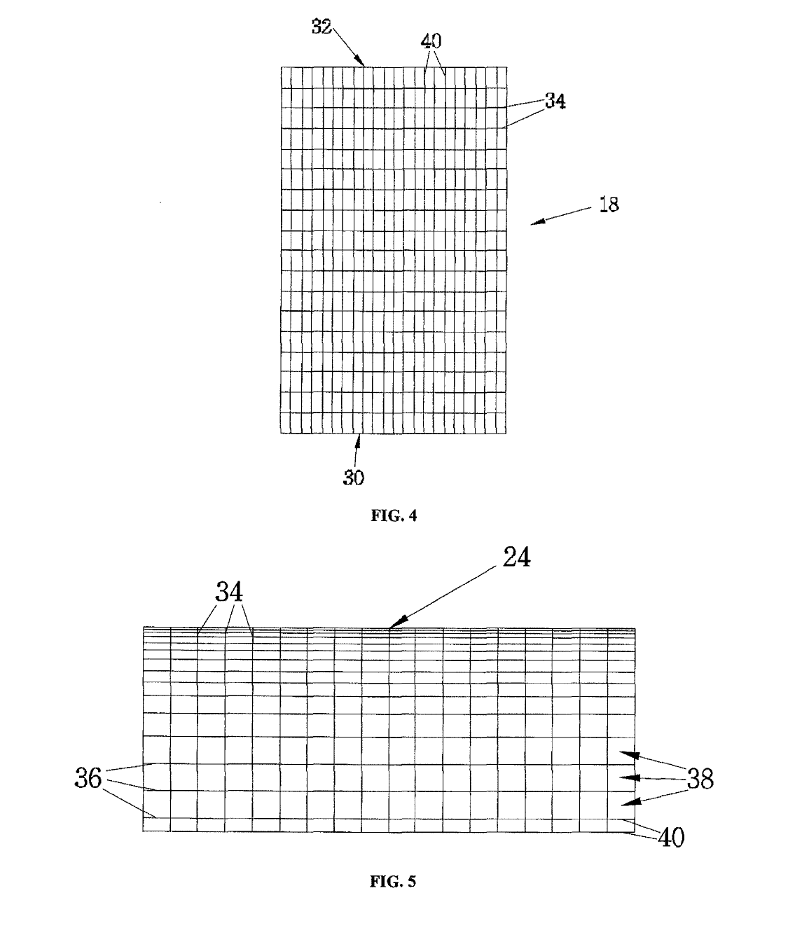

FIG. 4 shows a bottom view of the bent base panel 18 of the trap, constructed of a rectangular line wire 34 and fill wire 40.

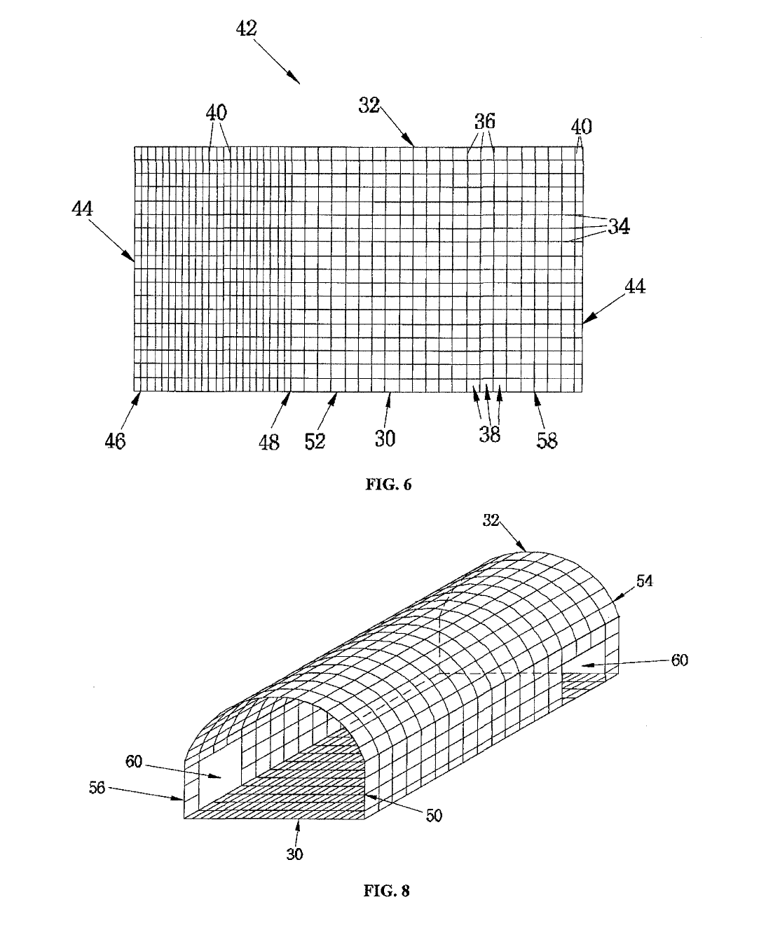

The method of forming the continuous mesh body 12 begins with the provision of a rectangular welded panel 42, as shown in FIG. 6. The panel is constructed of intersecting line wires 34 and fill wires of two spacing, equal 36 and half 40. The panel is configured with parallel front wire 30 and back wire 32 and parallel side wires 44.

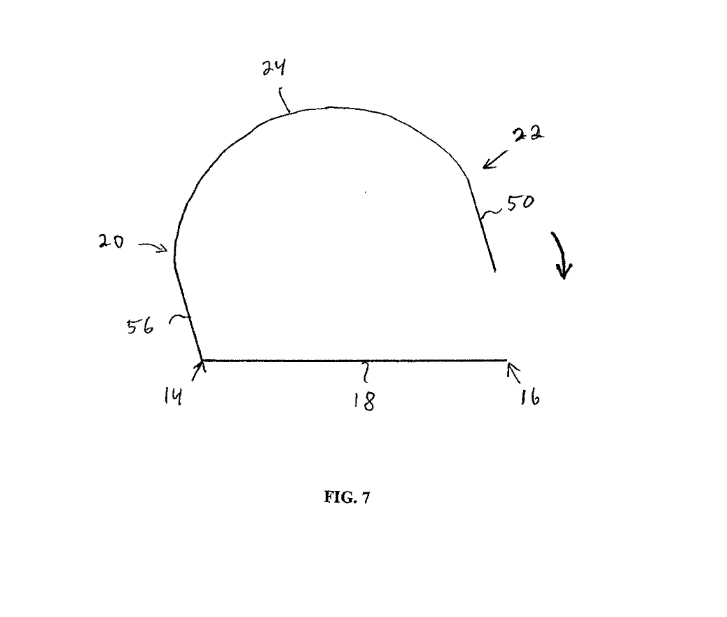

With reference to FIG. 7, the rectangular welded body panel 42 is then bent 90 degrees 14 one fill wire from the left side 46. The second bend 16 is then inserted at the end of the half spacing 48 to create the formed base panel 18. The right side wall 50 is then formed from the obtuse bend 20 partly up the equal fill wire spacing at 52. The top round 24 is then formed manually or pressed into a mold (not shown) to create the desired curvature 54. The final left vertical wall 56 is constructed by creating a second equal obtuse bend 22 located towards the end of the panel at 58.

The two parallel side wires 44 are then fastened to each other to create the continuous mesh body 12. The front panel and back panel are then fastened to the front wire 30 and back wire 32.

In FIG. 8, the two vertical body walls 50 and 56 are trimmed, by having material cut away to create the entryways 60 for the nylon mesh funnel 62 to be fastened to.

In light of the forgoing, it will now be appreciated by those skilled in that art that the cage of the present invention is relatively light weight with an integral welded construction fully capable of withstanding rigorous usage and exposure to salt water and the elements.

Those skilled in the art will appreciate that numerous modifications and variations may be made to the above disclosed embodiment without departing from the spirit and scope of the present invention.

What is claimed is:

1. A cage for trapping crustaceans constructed in the shape of a rounded top creel comprising a continuous body constructed of said rectangular welded panel to be bent into the shape of the cage.

2. The cage of claim 1 wherein said line wires are secured to said fill wires by welding.

3. A method of forming a cage for trapping crustaceans constructed in the shape of a rounded top creel, said method comprising the steps of providing a rectangular mesh body panel; providing a curve in said rectangular body mesh panel such that a first portion of the mesh body panel is provided as a base of the cage, and second portion of the mesh body panel is provided as side walls and the rounded top of the cage; and attaching an edge of the first portion of the mesh body panel to an edge of the second portion of the mesh body panel.

4. A method of forming a cage for trapping crustaceans constructed in the shape of a rounded top creel, said method comprising the steps of:
providing a rectangular wire mesh body panel having parallel fill wires extending from a bottom edge to a top edge of said panel, and parallel line wires extending from one side edge to the other side edge of said panel, said fill and line wires being secured to one another at cross over locations to thereby define discrete rectangular openings, said body panel including an arrangement of half and full spaced fill wires, and said body panel being trimmed to create two side openings;
interconnecting the side edges, consisting of two fill wires, of the thus formed body panel;
providing two smaller rectangular wire mesh body panels having parallel fill wires extending from a front edge to a back edge of said panel, and parallel line wires extending from one side edge to the other side edge of said panel;
trimming said panels to enclose the front and back openings produced from interconnecting the sides of the thus formed body panel;
interconnecting said front and back panels to the exposed edges of the thus formed body panel; and
interconnecting two nylon funnels to the two cut opens in the side of the body panel.
